(19) United States
(12) Patent Application Publication
(10) Pub. No.: US 2021/0208315 A1
(43) Pub. Date: Jul. 8, 2021

(54) LIGHT DIFFUSION FILM MODULE AND LIGHT SOURCE MODULE USING THE SAME

(71) Applicant: CHI HSIANG OPTICS CO., LTD., Hsinchu City (TW)

(72) Inventors: Po-Hung YAO, Hsinchu City (TW); Chih-Hua FENG, Hsinchu City (TW)

(21) Appl. No.: 17/141,831

(22) Filed: Jan. 5, 2021

Related U.S. Application Data
(60) Provisional application No. 62/958,518, filed on Jan. 8, 2020.

(51) Int. Cl. G02B 5/02; F21V 13/04

(52) U.S. Cl. CPC G02B 5/0236; F21Y 2115/10; F21V 13/04; G02B 5/0278

(57) ABSTRACT

A light diffusion film module including stacked first and second optical films is stacked on an array light source to form a light source module, Light incident and outputting sides of the first optical film are respectively provided with irregularly array-arranged first optical elements and array-arranged second optical elements, which are not aligned in position one by one. Inclined lateral faces of the first optical elements are partially parallel and inclined lateral faces of the second optical elements are partially parallel. The second optical film has a light incident side adjacent to the first optical film, and a light outputting side with regularly arranged third optical elements. Inclined lateral faces of the third optical elements are parallel. As such, the light diffusion film module can effectively and uniformly diffuse the light from the array light source in a short distance and eliminate direct glare under good light emitting efficiency.

### CROSS REFERENCE TO RELATED APPLICATIONS

This non-provisional application claims the benefit under 35 U.S.C. § 119(e) to U.S. Provisional Application No. 62/958,518, filed on Jan. 8, 2020, which is hereby expressly incorporated by reference into the present application.

### BACKGROUND OF THE INVENTION

### 1. Field of the Invention

The present invention relates generally to light diffusion film modules and light source modules, and more particularly, to a light diffusion film module capable of effectively diffusing light in a short optical distance and a light source module composed of the light diffusion film module and an array light source.

### 2. Description of the Related Art

With the continuous improvement of luminous efficiency and manufacturing technology of light-emitting diode (LED), direct planar light source modules using ultra-small LED chip array without light guiding plates have become feasible and commercializable. In consideration of both factors of minimizing module and optimal light field distribution, the current light diffusion elements, including diffusion plates and diffusion films, are not suitable for the aforesaid ultra-small light source module because the light diffusion element must be spaced from the LED light source at a certain optical distance (OD) in order to achieve effective diffusivity. If the optical distance is insufficient, the point-like light of the LED light source will not be uniformly distributed over the light emitting surface of the light source module, resulting in hot spots on the light emitting surface to cause direct glare to the observer. As a result, the observer's eyes may feel discomfort.

To solve the above-mentioned deficiency, a general measure is to print a plurality of light shielding patterns made of high reflective and light non-absorbing material on the light diffusion element in a way that the patterns are located above and S aligned with the LEDs, thereby eliminating glare. However, this measure will cause inconvenience in assembly and alignment of the light diffusion element and the LEDs, and will deteriorate the light emitting efficiency of the LED light source.

### SUMMARY OF THE INVENTION

The present invention has been accomplished in view of the above-noted circumstances. It is an objective of the present invention to provide a light diffusion film module, which can solve the problems of insufficient light diffusivity and direct glare caused by ultra-short optical distance to the light diffusion element. The light diffusion film module which is adapted to be used with an array light source to collectively form an ultra-small direct planar light source module, can maintain effective light diffusivity, guide the light of the array light source to uniformly emit therefrom, and eliminate direct glare without deteriorating light emitting efficiency under the condition that the light diffusion film module is spaced from the array light source at an ultra-short optical distance.

To attain the above objective, the present invention provides a light diffusion film module comprising a first optical film and a second optical film stacked on the first optical film. The first optical film comprises a first substrate having a first light incident side and a first light outputting side, a plurality of first optical elements, and a plurality of second optical elements. The first optical elements are irregularly arranged as an array on the first light incident side of the first substrate. The second optical elements are arranged as an array on the first light outputting side of the first substrate. Each first optical element includes at least one first inclined lateral face non-parallel to the first substrate. The first inclined lateral faces of the first optical elements are partially parallel thereamong. Each second optical element includes at least one second inclined lateral face non-parallel to the first substrate. The second inclined lateral faces of the second optical elements are partially parallel thereamong. The first optical elements and the second optical elements are configured as not being aligned in position one by one. The second optical film includes a second substrate and a plurality of third optical elements. The second substrate has a second light incident side adjacent to the first optical film, and a second light outputting side on which the third optical elements are arranged as an array. Each third optical element includes at least one third inclined lateral face non-parallel to the second substrate. The present invention further provides a light source module comprising an array light source and the aforesaid light diffusion film module stacked on the array light source.

With the special design of the shapes and distributions of the microstructures on the optical films, the light diffusion film module of the present invention can maintain better light uniformity and light emitting efficiency under a short optical distance, facilitating thinnerization and miniaturization of the light source module to enable small-sized application.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by of illustration only, and thus are not limitative of the present invention, and wherein:

FIG. 1 is a schematically exploded view of a light source module according to a first embodiment of the present invention;

FIG. 2 is a schematically exploded plane view of the light source module of the first embodiment of the present invention;

FIG. 3 is a schematic perspective view showing structures and distribution of first optical elements in accordance with the first embodiment of the present invention;

FIG. 4 is a schematic perspective view showing structures and distribution of second optical elements in accordance with a first form of the first embodiment of the present invention;

FIG. 5 is a schematic perspective view showing structures and distribution of the second optical elements in accordance with a second form of the first embodiment of the present invention;

FIG. 6 is a schematic perspective view showing structure of the second optical element in accordance with a third form of the first embodiment of the present invention;

FIG. 6A is a schematic view showing the distribution of the second optical elements in accordance with the third form of the first embodiment of the present invention;

FIG. 7 is a schematic perspective view showing a second optical film according to the first embodiment of the present invention; and

FIG. 8 is a schematically exploded plane view of a light source module according to a second embodiment of the present invention.

### DETAILED DESCRIPTION OF THE INVENTION

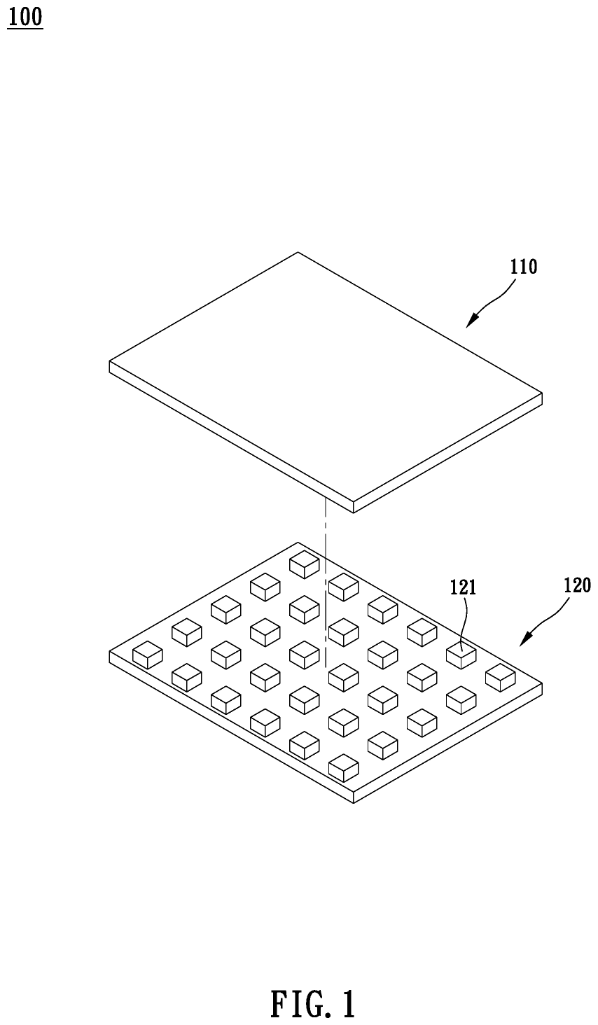

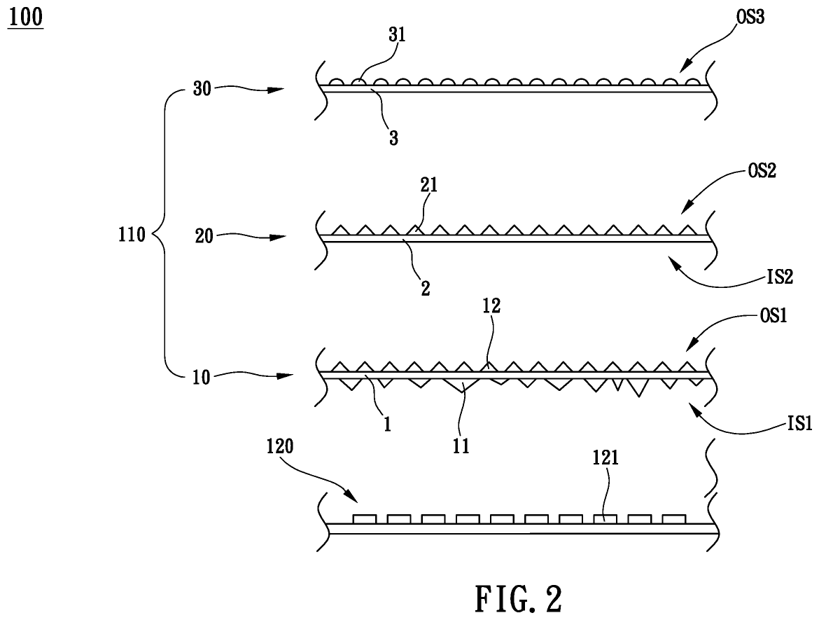

The present invention is related to a light diffusion film module and a light source module. By means of the following embodiments and accompanying drawings, the technical features and effects of the present invention will be detailedly illustrated. As shown in FIGS. 1 and 2, a light source module 100 provided by a first embodiment of the present invention is composed of a light diffusion film module 110 and an array light source 120. For the array light source 120, an LED chip array may be, but not limited to be, used. The light diffusion film module 110 comprises a first optical film 10 and a second optical film 20 stacked on the first optical film 10. For convenient illustration, the array light source 120, the first optical film 10 and the second optical film 20 are sketched in the drawings separately. In fact, these elements are tightly stacked one after another. One or both of the first and second optical films 10 and 20 are made of transparent material. The film may be integrally made by polycarbonate, or made by printing ultraviolet-curable ink on a transparent film and then cured by UV light.

As shown in FIG. 2, the first optical film 10 includes a first substrate 1 having a first light incident side IS1 and a first light outputting side OS1. On the first light incident side IS1, a plurality of first optical elements 11 are irregularly arranged as an array. On the first light outputting side OS1, a plurality of second optical elements 12 are arranged as an array. The first substrate 1, the first optical elements 11 and the second optical elements 12 may be made of materials having same or different refractive indexes. The second optical elements 12 may arranged regularly or irregularly as an array. The so-called ‘irregularly arranged as an array” means the microstructures, e.g. the first optical elements or the second optical elements, are arranged and distributed in a manner having no regularity and consistency at all.

In the first embodiment of the light source module of the present invention, the first optical elements 11 and the second optical elements 12 have shapes of quadrangular right pyramid or quadrangular oblique pyramid, which has an apex angle ranging from 30 degrees to 120 degrees, and preferably has an apex angle of 90 degrees. However, it is to be understood that the shapes of the first and second optical elements 11 and 12 are not limited to the disclosure of this embodiment. For example, the first optical elements 11 may have shapes of polygonal pyramid, such as triangular pyramid, pentagonal pyramid, cone, frustum, or a combination thereof, and the second optical elements 12 may have shapes of semi-sphere, semi-spheroid, polygonal pyramid, cone, frustum or a combination thereof.

In the first embodiment of the light source module of the present invention, the sizes of the first optical elements 11 are not all the same, i.e. may be partially the same. Specifically, at least ones of the lengths, widths and heights of the quadrangular pyramids are not all the same. In contrast, the sizes of the second optical elements 12 are all the same. However, it is to be understood that aforesaid design of size is not limited to the disclosure of this embodiment. For example, the first optical elements 11 may be configured as having a same size, and the second optical elements 12 may be configured as having sizes not all the same.

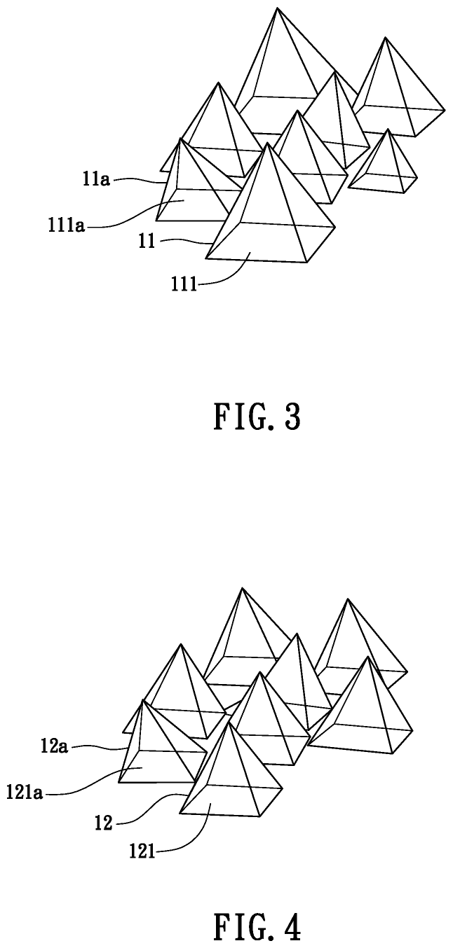

Referring to FIGS. 2-4, FIG. 3 shows the structures and distribution of the first optical elements 11 of the first embodiment of the present invention, and FIG. 4 shows the structures and distribution of the second optical elements 12 of the first embodiment of the present invention. As shown in FIGS. 3 and 4, in the first embodiment of the present invention, the first and second optical elements 11 and 12 are irregularly arranged in a way that each adjacent two of the first optical elements 11 or the second optical elements 12 are spaced at an interval, and the intervals of the first optical element 11 or the second optical elements 12 are not all the same, i.e. are partially the same. However, the first optical elements 11 may be configured as having a same interval as long as they are irregularly distributed, and the second optical elements 12 may be configured as having a same interval as long as they are irregularly distributed. The aforesaid “interval” of adjacent first optical elements 11 or second optical element 12 means the distance between the apexes of two adjacent quadrangular pyramids.

As shown in FIG. 3, each first optical element 11 has four first inclined lateral faces 111 non-parallel to the first substrate 1. For concise illustration, hereunder the inclined lateral faces facing the reader who views FIG. 3 will be taken as an example for discussion. The first inclined lateral faces (e.g. the first inclined lateral faces 111 and 111a), which face a same direction (e.g. face the reader), of the first optical elements (e.g. first optical elements 11 and 11a) are not all parallel thereamong. That is, in the first inclined lateral faces that face a same direction, at least one of the first inclined lateral faces is configured as being non-parallel to the others. It is to be understood that in the first inclined lateral faces that face a same direction, all of the first inclined lateral faces may be configured as being non-parallel to each other. FIG. 4 shows the second optical elements in accordance with a first feasible form. As shown in FIG. 4, each second optical element 12 has four second inclined lateral faces 121 non-parallel to the second substrate 2. For concise illustration, hereunder the inclined lateral faces facing the reader who views FIG. 4 will be taken as an example for discussion. The second inclined lateral faces (e.g. the second inclined lateral faces 121 and 121a), which face a same direction (e.g. face the reader), of the second optical elements (e.g. second optical elements 12 and 12a) are not all parallel thereamong. That is, in the second inclined lateral faces that face a same direction, at least one of the second inclined lateral faces is configured as being non-parallel to the others. Of course, in the second inclined lateral faces that face a same direction, all of the second inclined lateral faces may be configured as being non-parallel to each other. Further, the positions of the first optical elements 11 and the positions of the second optical elements 12 at two opposite sides of the first optical film 10 are not aligned one by one. In fact, the shapes of the first optical elements 11 are not limited as long as the first optical elements 11 each have at least one said first inclined lateral face 111. Similarly, the shapes of the second optical elements 12 are not limited as long as the second optical elements 12 each have at least one said second inclined lateral face 121. With the structural features of the first and second optical elements 11 and 12, the light incident into the first optical film 10 will be firstly refracted by the first optical elements 11 in various angles, and then refracted upwardly by the second optical elements 12 in various angles out of the first optical film 10, or then reflected downwardly by the second optical elements 12 in various angles and thereafter reflected upwardly by the first optical elements 11. With the aforesaid repeated refractive and/or reflective processes, the incident light can be uniformly emitted out of the first optical film 10.

In another embodiment of the present invention, the first optical film 10 further comprises a wavelength converted layer (not shown) located between the first substrate 1 and the first optical elements 11. The wavelength converted layer comprises a wavelength converted material that can convert an incident light having a first wavelength into an excitation light having a second wavelength longer than the first wavelength, e.g. converting into white light. In another embodiment of the present invention, the first substrate 1 comprises the wavelength converted material. For the wavelength converted material, fluorescent powders may be used. In still another embodiment of the present invention, the wavelength converted layer or wavelength converted material may be omitted. For example, when the light source 120 emits white light, the wavelength converted layer or wavelength converted material can be omitted.

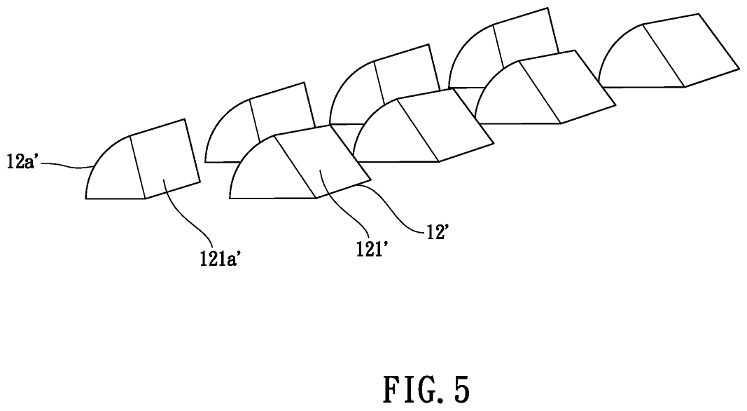

In another embodiment of the present invention, the second optical elements 12 are linearly arranged in the array distribution. Referring to FIG. 5, it shows the second optical elements in accordance with a second feasible form. As shown in FIG. 5, the second optical elements 12′ and 12a′ are configured as being sector-shaped columns linearly arranged along two lines. The top end of the sector-shaped column is terminated as a ridge line, and two lateral faces extending downwardly from the top end are an inclined face and an arc face, such that the sector-shaped column has a sector-shaped cross-section. Each second optical element 12′ has a second inclined face 121′ non-parallel to the first substrate 1. The second optical element 12′ and the second optical elements 12a′ have different dimensional features, such that the second inclined faces 121′ of the second optical elements 12′ and the second inclined faces 121a′ of the second optical elements 12a′ are not all parallel thereamong.

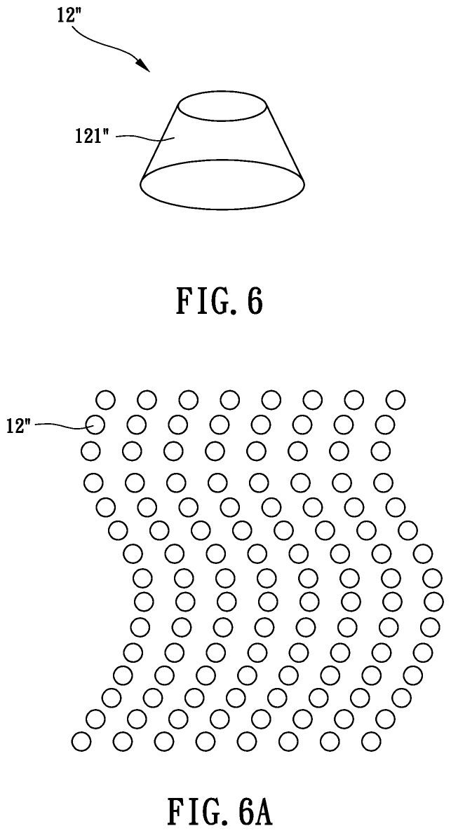

Referring to FIGS. 6 and 6A, they show the second optical elements in accordance with a third feasible form. As shown in FIGS. 6 and 6A, the second optical elements 12″ have a shape of frustum, and they are arranged along curve lines in the array distribution. Each second optical element 12″ has at least one second inclined lateral face (arc face) 121″ non-parallel to the first substrate 1, and the second inclined lateral faces 121″ of the second optical elements 12″ are not all parallel to each other.

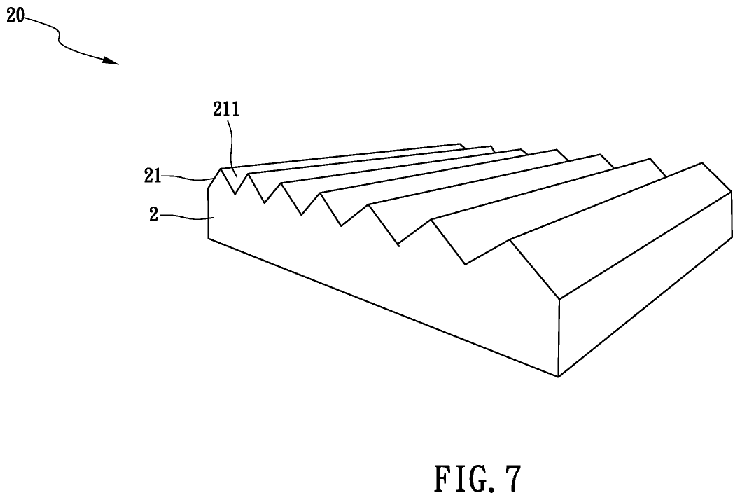

Referring to FIGS. 2 and 7, FIG. 7 shows the schematic structure of the second optical film in accordance with the first embodiment of the present invention. The second optical film 20 includes a second substrate 2 having a second light incident side IS2 adjacent to the first optical film 10, and a second light outputting side OS2. Preferably, the second light incident side IS2 of the second substrate 2 is a rough surface or matte surface for changing the refractive angle of the incident light. However, the second light incident side IS2 may be a smooth surface. On the second light outputting side OS2, a plurality of third optical elements 21 are provided. These third optical elements 21 may be irregularly or regularly arranged as an array, and may be configured as having, but not limited to, a shape of polygonal pyramid, cone, frustum, strip, or a combination thereof. The second substrate 2 and the third optical elements 21 may be made of materials having same or different refractive indexes.

As shown FIG. 7, each third optical element 21 has at least one third inclined lateral face 211 non-parallel to the second substrate 2. In this embodiment, the third optical elements 21 are configured as being strip bodies, which are regularly arranged on the second light outputting side OS2 of the second optical film 20, such that the third inclined lateral faces 211 are all parallel to each other. In fact, the shapes of the third optical elements 21 are not limited as long as the third optical elements 21 each have at least one said third inclined lateral face 211. In this embodiment, the intervals of each adjacent two of the third optical elements 21 are the same. The aforesaid “interval” means the distance between the apexes of two adjacent third optical elements 21. As a result, the third optical elements 21 may reflect part of light downwardly to enable the first optical film 10 to uniform the light and then reflect back the uniformed light upwardly, and the other part of the light may be refracted with specific refractive angle and emitted upwardly.

Referring to FIG. 2, the light diffusion film module 110 may further comprise a third optical film 30 stacked on the second optical film 20. The third optical film 30 comprises a third substrate 3 having a third light outputting side OS3. On the third light outputting side OS3 of the third substrate 3 of the third optical film 30, a plurality of fourth optical elements 31 are arranged in an array. Each fourth optical element 31 has an arc-shaped structure protruding in a direction away from the third substrate 3, thereby achieving an optical effect of convex lens. In this embodiment, the sizes of the fourth optical elements 31 are all the same, and the intervals between any two of the fourth optical elements 31 are the same. As such, the third optical film 30 can further uniform the light emitted upwardly. In another embodiment, the sizes of the fourth optical elements 31 are not all the same, and the intervals between any two of the fourth optical elements 31 are not all the same. In still another embodiment, the third optical film 31 is omitted.

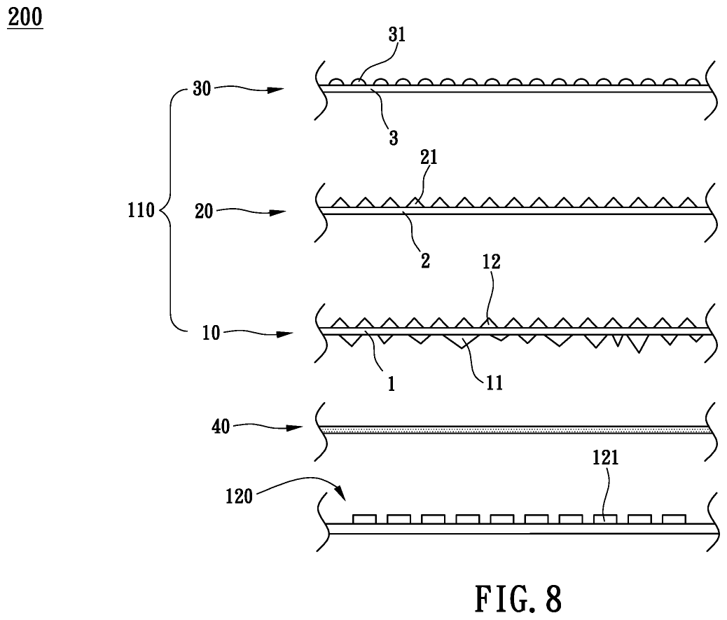

Referring to FIG. 8, it shows schematic structure of a light source module in accordance with a second embodiment of the present invention. In this second embodiment of the present invention, the light source module 200 further comprises a wavelength converted layer 40 located between the array light source 120 and the light diffusion film module. The wavelength converted layer 40 comprises a wavelength converted material that can convert an incident light having a first wavelength into an excitation light having a second wavelength longer than the first wavelength. For wavelength converted material, fluorescent powders may be used.

In conclusion, the light diffusion film module 110 of the present invention comprises a first optical film 10 having multidirectional refractive and reflective microstructures on both sides thereof, and a second optical film 20 capable of total reflecting a small angle of incidence of the light emitted from the array light source 120. The first light incident side IS1 of the first optical film 10 is provided with a plurality of first optical elements 11 irregularly arranged as an array, and the first light outputting side OS1 of the first optical film 10 is provided with a plurality of second optical elements 12 arranged as an array in a way that the positions of the first optical elements 11 and the positions of the second optical elements 12 are not in alignment with one by one, each first optical element 11 includes a first inclined lateral face 111 and the first inclined lateral faces 111 are not all parallel to each other (i.e. are partially parallel thereamong), and each second optical element 12 includes a second inclined lateral face 121 and the second inclined lateral faces 121 are not all parallel to each other (i.e. partially parallel thereamong). The second light incident side IS2 of the second optical film 20 is adjacent to the first optical film 10, and the second light outputting side OS2 of the second optical film 20 is provided with a plurality of third optical elements 21 regularly arranged in a way that each third optical element 21 includes a third inclined lateral face 211 and the third inclined lateral faces 211 are parallel with each other. By means of the unique designs in shapes and distributions to the microstructures, such as first, second and third optical elements 11, 12 and 13, the light diffusion film module 110 of the present invention can maintain effective light diffusivity and guide the light of the array light source 120 to emit uniformly under a short optical distance between the light diffusion film module 110 and the array light source 12, and can eliminate the direct glare under better light emitting efficiency.

The invention being thus described, it will be obvious that the structures of the light diffusion film module 110 and the light module 100 may be varied in many ways. Such variations are not to be regarded as a departure from the spirit and scope of the invention, and all such modifications as would be obvious to one skilled in the art are intended to be included within the scope of the following claims.

What is claimed is:

1. A light diffusion film module, comprising:
a first optical film including a first substrate, a plurality of first optical elements irregularly arranged as an array on a first light incident side of the first substrate, and a plurality of second optical elements arranged as an array on a first light outputting side of the first substrate, each of the first optical elements including at least one first inclined lateral face non-parallel to the first substrate, the first inclined lateral faces of the first optical elements being partially parallel thereamong, each of the second optical elements including at least one second inclined lateral face non-parallel to the first substrate, the second inclined lateral faces of the second optical elements being partially parallel thereamong, the first optical elements and the second optical elements being configured as not being aligned in position one by one; and
a second optical film stacked on the first optical film, the second optical film including a second substrate and a plurality of third optical elements arranged as an array on a second light outputting side of the second substrate, each of the third optical elements including at least one third inclined lateral face non-parallel to the second substrate, and the second substrate including a second light incident side adjacent to the first optical film.

2. The light diffusion film module as claimed in claim 1, wherein at least one of the first and second optical films is made of a transparent material.

3. The light diffusion film module as claimed in claim 1, wherein each adjacent two of the first optical elements are spaced at an interval; the intervals of the first optical elements are partially the same.

4. The light diffusion film module as claimed in claim 1, wherein each of the first optical elements has a shape of polygonal pyramid, cone, frustum, or a combination thereof.

5. The light diffusion film module as claimed in claim 1, wherein each of the first optical elements has a size, and the sizes of the first optical elements are partially the same.

6. The light diffusion film module as claimed in claim 1, wherein each of the second optical elements has a shape of semi-sphere, semi-spheroid, polygonal pyramid, cone, frustum, or a combination thereof.

7. The light diffusion film module as claimed in claim 1, wherein the second optical elements are linearly arranged on the first light outputting side of the first substrate.

8. The light diffusion film module as claimed in claim 7, wherein each of the second optical elements has a shape of polygonal pyramid, frustum, sector-shaped column, or a combination thereof.

9. The light diffusion film module as claimed in claim 1, wherein the second optical elements are irregularly arranged on the first light outputting side of the first substrate.

10. The light diffusion film module as claimed in claim 1, wherein each adjacent two of the second optical elements are spaced at an interval; the intervals of the second optical elements are partially the same.

11. The light diffusion film module as claimed in claim 1, wherein the third optical elements are regularly arranged on the second light outputting side of the second substrate.

12. The light diffusion film module as claimed in claim 11, wherein each adjacent two of the third optical elements are spaced at an interval; the intervals of the third optical elements are the same.

13. The light diffusion film module as claimed in claim 1, wherein the third inclined lateral faces of the third optical elements are parallel thereamong.

14. The light diffusion film module as claimed in claim 1, wherein the second light incident side of the second substrate comprises a rough surface.

15. The light diffusion film module as claimed in claim 1, wherein each of the third optical elements has a shape of polygonal pyramid, cone, frustum, strip, or a combination thereof.

16. The light diffusion film module as claimed in claim 1, wherein the first substrate comprises a wavelength converted material that coverts an incident light having a first wavelength into an excitation light having a second wavelength longer than the first wavelength.

17. The light diffusion film module as claimed in claim 1, wherein the first optical film comprises a wavelength converted layer between the first substrate and the first optical elements; the wavelength converted layer comprises a wavelength converted material that converts an incident light having a first wavelength into an excitation light having a second wavelength longer than the first wavelength.

18. The light diffusion film module as claimed in claim 1, further comprising a third optical film stacked on the second optical film; the third optical film comprises a third substrate and a plurality of fourth optical elements arranged as an array on a third light outputting side of the third substrate; each of the fourth optical elements has an arc-shaped structure protruding in a direction away from the third substrate.

19. A light source module, comprising:
an array light source; and
the light diffusion film module of claim 1, which is stacked on the array light source.

20. The light source module as claimed in claim 19, further comprising a wavelength converted layer between the array light source and the light diffusion film module; the wavelength converted layer comprises a wavelength converted material that converts an incident light having a first wavelength into an excitation light having a second wavelength longer than the first wavelength.
